(19) United States
(12) Patent Application Publication
(10) Pub. No.: US 2024/0190760 A1
(43) Pub. Date: Jun. 13, 2024

(54) GREENHOUSE GLASS FOR REDUCTION OF OVERHEATING DURING THE HOT SEASONS

(71) Applicant: AGC GLASS EUROPE, Louvain-la-Neuve (BE)

(72) Inventors: Seyedmohammad SHAYESTEHAMINZADEH, Gosselies (BE); Daphné STASSEN, Saint-Servais (BE); Fabrice DUFOUR, Gosselies (BE)

(73) Assignee: AGC GLASS EUROPE, Louvain-la-Neuve (BE)

(21) Appl. No.: 18/554,901

(22) PCT Filed: Apr. 22, 2022
(86) PCT No.: PCT/EP2022/060708

§ 371 Date: Oct. 11, 2023

(30) Foreign Application Priority Data
Apr. 28, 2021 (EP) 21170853.2

(51) Int. Cl. C03C 17/34; G02B 1/115

(52) U.S. Cl. CPC C03C 17/3417; G02B 1/115; C03C 2204/08; C03C 2217/734; C03C 2217/75

(57) ABSTRACT

Greenhouses designed for hot climate geographical zones and hot periods of a year in both hot and cold climate geographical zones. The greenhouses are made with a specific coated glass allowing a very high hemispherical transmittance, a very high PAR transmittance and a tunable hortiscatter, when requested. The glazing contains a selectively high NIR reflectance and a high emissivity of glass, to allow the heat to leave the greenhouse to avoid a high temperature increase in the greenhouse. The glass can perform longer due to its durability.

### TECHNICAL FIELD

The present invention relates to greenhouses designed mainly for hot climate geographical zones and hot period of seasons in both hot and cold climates. They are made with specific coated glass allowing a very high PAR and hemispherical transmittance and an adapted hortiscatter. The coated glass of the invention allows high PAR transmission, selectively reflects NIR radiations and permits high FIR re-emission due to high emissivity, avoiding a too high temperature increase inside the greenhouse. The glass is also characterized through a longest lasting performance thanks to its superior durability.

### BACKGROUND ART

People are familiar with the idea that greenhouses can greatly help to increase crops production in cold and/or less sunny geographical zones by keeping the crops in a sunny warm ambiance. This is why traditional greenhouses are designed to fit cold climate but little solutions exist for hot climate.

We know that the ideal temperature for most plants to flourish is roughly between 15 and 29° C. Increase of temperature in the greenhouse can rapidly become a problem and a temperature above 32° C. will be fatal for the production yield of common plants. An immediate solution is the ventilation of the greenhouse but this requires management of the system and results in a loss of carbon dioxide as well as incoming of undesired insects or whatsoever. Another possibility is to add a cooling system to the greenhouse but this is high energy consuming and thus has a negative impact on environment. The smartest solution would be to avoid a too high temperature instead of decreasing the temperature once it has started to increase. This can be done by periodically screening the greenhouse glasses with an nearly opaque system but once again this system is complicated to manage, and such a screening system results also in a loss of PAR light reducing the production.

Analysis of the situation reveals that the Near Infrared light (NIR, part of the light with a wavelength between 700 and 2000 nm) is not consumed by leaves for photosynthesis process but is instead responsible for a large part of temperature increase in the greenhouse while the PAR (photosynthetically active radiation is the part of the light with a wavelength between 400 and 700 nm) is necessary for a good crop growth.

EP2340706A1 disclosed a glass coated with a transparent conductive oxide (TCO) which is known for reflecting the near infrared radiation (NIR). The problem for a greenhouse application is that this coating also reflects the PAR light. While decreasing the NIR reflection is a good point to circumvent overheating, decreasing PAR transmission is a problem for crop growth. Surprisingly EP2340706A1 also discovers that adding an antireflective coating over the TCO coating had 2 positive effects for glass designated to be used in a greenhouse, those effects are: 1°) increase of the NIR reflectance and 2°) decrease of the PAR reflectance. This compromise is thus a first step in providing a coated glass which better control the temperature inside the greenhouse but it nevertheless still remains not fully satisfactory. Moreover, the hemispherical light transmission is still too low. Additionally, the low emissivity nature of the TCO coating results in significant heat trapping inside the greenhouse due to the fact that all the PAR transmitted which has not been consumed by leaves are converted to FIR radiations and contribute to the temperature increase inside the greenhouse while this coating does not allow the generated heat to escape and thus severe overheating occurs.

As a conclusion, we see there is a need for specific greenhouse glass designed for hot climates to protect plants from excessive heat and still allow a good production yield by having high PAR and good hemispherical transmission. For plant growth, it would be better to avoid any loss of the PAR transmission while still decreasing the NIR transmittance. As an additional feature, a high emissivity is desired to allow heat from inside to escape.

### SUMMARY OF INVENTION

It is an object of the present invention to provide a glazing element that is characterized by a higher light transmittance of wavelength comprised between 400 and 700 nm (PAR), a lower light transmittance of wavelength comprised between 700 and 2000 nm (NIR) and a high emissivity to allow heat evacuation.

We know that the light coming from the sun all along the day and all along the year, varies in intensity as a function of the incident angle. So when speaking about a greenhouse, and because of the importance of this intensity on the growth process, it makes sense to consider the hemispherical light (Tₕₑₘ) intensity instead of an direct incident light with a specific angle related to the glass surface. Another important parameter for the use of a glazing in a greenhouse is the way the incoming light is diffused inside the greenhouse. A specular transmission may be responsible for the burning of a plant while a diffused transmission allows a better light distribution in the entire space without hot spot. This diffused light can also better penetrate inside the crop canopy enabling the inside leaves to have access to the light and contributing in photosynthesis process.

The highly PAR transmitting glazing of this invention has an hemispherical light transmittance of at least 83%, preferably 89% and more preferably 91%.

The highly PAR transmitting glazing of this invention has a PAR light transmittance of at least 92%, preferably of at least 94%, more preferably of at least 96% and at most preferably of at least 98%.

The highly PAR transmitting glazing of the invention is characterized by a NIR reflectance of at least 18%, preferably at least 19% and more preferably at least 20%.

The highly PAR transmitting glazing of the invention is characterized by a high emissivity which is at least 80%, preferably at least 83% and more preferably at least 85%. Such a high emissivity is due to the high absorption of glass in the vicinity of 5000 nm which results in a large amount of heat escape from the greenhouse and allows, in combination with a low NIR transmittance to avoid overheating in the greenhouse.

In a first embodiment, the highly PAR transmitting glazing for a greenhouse of this invention comprises (a) a clear or extra-clear glass, (b) an antireflective coating on at least one face of said clear or extra-clear glass, said antireflective coating comprising a first layer characterized by a high refractive index, a second layer characterized by a low refractive index, a third layer characterized by a high refractive index and a fourth layer characterized by a low refractive index.

In a second embodiment of the invention, the glass surface coated with the antireflective coating has been textured prior to the deposition of said coating. Texturing of the glass surface is performed through a mechanical or a chemical process, by methods well known from the man skilled in the art. The textured surface may be manufactured through calendaring, sand blasting or chemical etching. Chemical etching may be performed by any known procedure in the art such as dipping, spraying, roller etching, curtain etching. In this second embodiment the surface of the glass is characterized by a roughness having parameters defined in the table 1.

TABLE 1

| | | |
|---|---|---|
| preferred | More preferred | Most preferred |

| | | | | | | |
|---|---|---|---|---|---|---|
| Sa | ≥0.05 | μm | ≥0.10 | μm | ≥0.20 | μm |
| Sa | ≤3 | μm | ≤2.5 | μm | ≤2 | μm |
| Sz | ≥1 | μm | ≥2 | μm | ≥3 | μm |
| Sz | ≤12 | μm | ≤10 | μm | ≤9 | μm |
| Rsm | ≥50 | μm | ≥55 | μm | ≥60 | μm |
| Rsm | ≤150 | μm | ≤140 | μm | ≤130 | μm |

For example, texturing may be obtained by means of a controlled chemical attack with an aqueous solution based on hydrofluoric acid, carried out one or more times. Generally, the aqueous acidic solutions used for this purpose have a pH between 0 and 5 and they can comprise, in addition to the hydrofluoric acid itself, salts of this acid, other acids, such as HCl, H₂SO₄, HNO₃, CH₃CO₂H, H₃PO₄ and/or their salts (for example, Na₂SO₄, K₂SO₄, (NH₄)₂SO₄, BaSO₄, and the like), and also other adjuvants in minor proportions. Alkali metal and ammonium salts are generally preferred, such as, for example, sodium, potassium and ammonium bifluoride. The acid etching stage according to the invention can advantageously be carried out by controlled acid attack, for a time which can vary as a function of the acid solution used and of the expected result. This means that the final desired hortiscatter is fixed by adjusting the etching conditions.

Advantageously in this embodiment the coated side of the etched-glazing is facing the inside of the greenhouse.

In a third embodiment, a single side of the highly PAR transmitting glazing of the invention is textured. One antireflective coating is deposited on the textured glass surface and one antireflective coating is deposited on the opposite non-textured glass surface. Advantageously said textured side is oriented to the inside of the greenhouse.

For any of the embodiments, by layer characterized by a high refractive index, it is meant a layer having a refractive index that is at least 1.9, preferably at least 2.1, more preferably at least 2.2 and most preferably at least 2.35. By layer characterized by a low refractive index, it is meant a layer having a refractive index that is at most 1.7, preferably at most 1.55 and more preferably at most 1.45.

Advantageously the antireflective coating of this invention is comprising a first oxide layer with a high refractive index in a thickness comprised between 5 and 15 nm, a second oxide layer with a low refractive index in a thickness comprised between 30 and 50 nm, a third oxide layer with a high refractive index in a thickness comprised between 100 and 130 nm and a fourth oxide layer with a low refractive index in a thickness comprised between 80 and 110 nm.

Advantageously, the fourth layer of the antireflective coating, is a two parts oxide layer comprising a first part and a second part, both part being oxide layers characterized by a low refractive index.

Advantageously, the low refractive index oxide layers comprise silicon oxide (SiOₓ). SiOₓ means a layer based on silicon oxide that may contain other elements and x is equal or smaller than 2.

Advantageously the high refractive index oxide layers comprise titanium oxide.

More advantageously, the high refractive index oxide layers are a mixed oxides comprising titanium oxide and zirconium oxide. Preferably the mixed oxide has a weight composition of TiO₂/ZrO₂ (TZO) comprised between 50/50 and 75/25. More preferably the mixed oxide layer comprising titanium oxide and zirconium oxide has a weight composition of about TiO₂/ZrO₂: 65/35.

Advantageously the antireflective coating of the invention is deposited on the glass surface facing any of the inside or outside side of the greenhouse.

In a preferred way the oxide layers of the antireflective coating are deposited by a very well-known PVD process.

Alternatively one or more than one oxide layer of the antireflective coating may be deposited through a process known in the art as a PECVD process.

As another advantage, the inventors have discovered that in any of the embodiments, the coated side of the glazing of the invention has an enhanced hydrophilicity, characterized by a water contact angle that is at most 32°, preferably at most 30° and more preferably at most 29°. This property is mainly a result of combining textured surface with the antireflective coating while the antireflective coating by itself also present such a property. Such a low water contact angle allows water inside the greenhouse to form a film instead of drops and as a result, elevating the hemispherical light transmittance in wet condition.

Another advantage of using our specific antireflective coated glazing is that this highly PAR transmitting glazing is responsible for a better protection against glass corrosion. This makes the glazing of the invention more durable and allows a long lasting performance. The highly PAR transmitting glazing of the invention is a class A conformed to the norm EN 1096 regarding its durability.

It has also been found that by adjusting the glass surface texture, it was possible to vary the hortiscatter from 0% (no texturing) up to 75%.

The highly PAR transmitting glazing of the invention may be heat treated and is conform to the norm EN 12150-1-2015.

### BRIEF DESCRIPTION OF DRAWINGS

This and other aspects of the present invention will now be described in more detail, with reference to the appended drawings and by showing various exemplifying embodiments of the invention.

FIG. 1 shows the structures corresponding to the three embodiments of the invention: FIG. 1a illustrates the first embodiment; FIG. 1b illustrates the second embodiment; FIG. 1c illustrates the third embodiment.

FIG. 2 is a graph of the light transmittance from 300 to 2500 nm of the coated glass of the invention (solid line) and a low iron float glass (dashed line).

FIG. 3 is a graph of the light reflectance from 300 to 2500 nm of the invention (solid line) and a low iron float glass (dashed line).

FIG. 4 is a graph of the light transmittance from 700 to 5000 nm of the coated glass of the invention (solid line) and a low iron float glass (dashed line).

FIG. 5 is a graph of the light reflectance from 700 to 5000 nm of the invention (solid line) and a low iron float glass (dashed line).

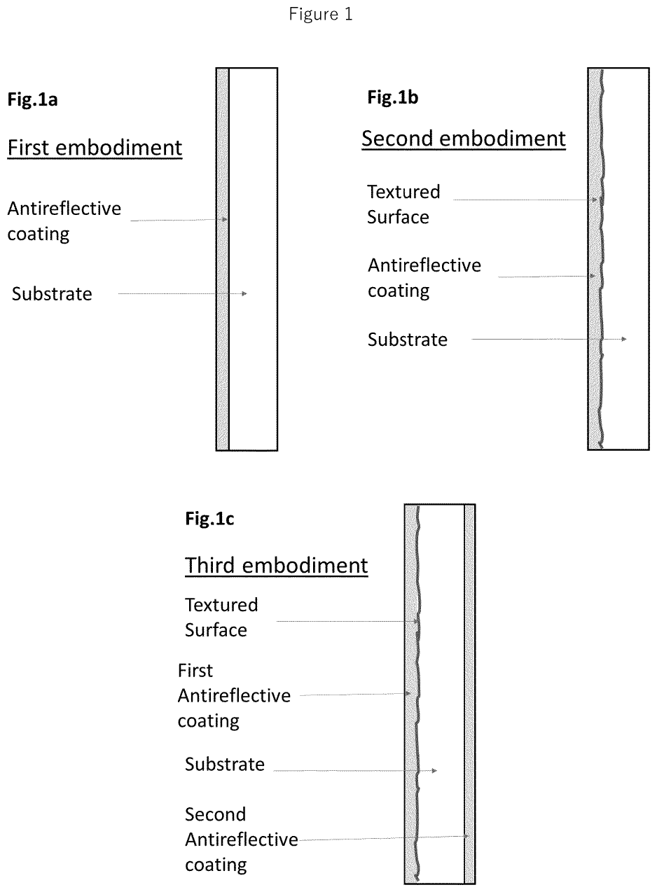

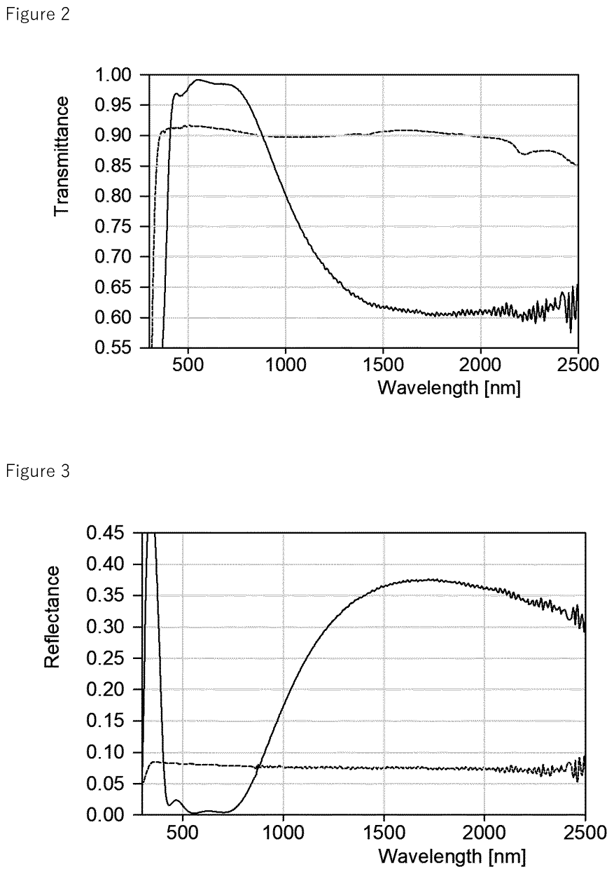

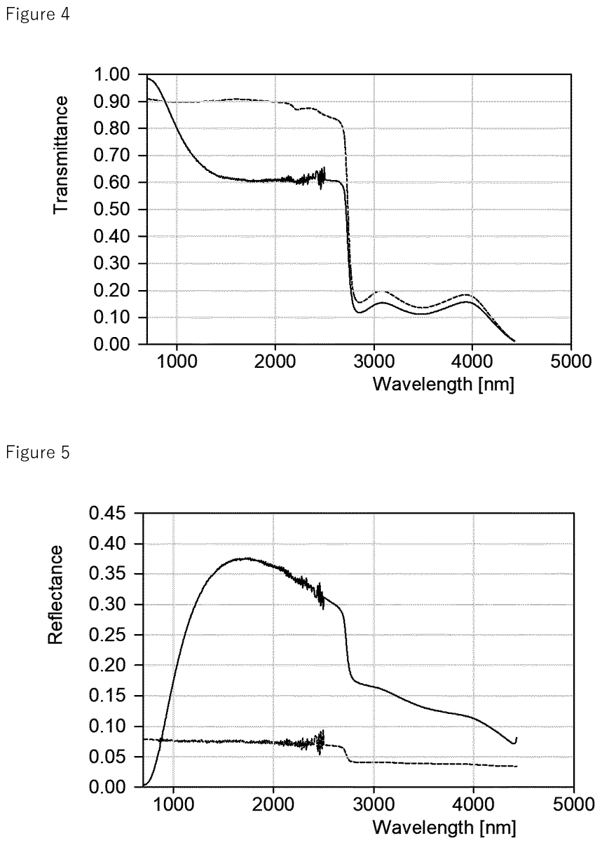

### DESCRIPTION

The features of our invention are the consequence of a combination of glass quality, glass surface treatment or not and deposition of an antireflective coating on one or both sides of a glass substrate. Each of those characteristics will now be described with more details.

### Definitions

PAR meaning is photosynthetically active radiation and comprises wavelength between 400 to 700 nm, based on NEN 2675+C1:2018. This is the main part of natural light responsible for photosynthetic activities of plants.
Near infrared radiations (NIR) is defined as the light wavelength comprised between 700 and 2000 nm, based on NEN 2675+C1:2018.
Within the context of horticulture, Hortiscatter is the integral value of geometrical distribution of light intensity by bi-directional transmittance (or reflectance) distribution function BTDF under a given angle of incidence of incoming light beam (3D data), defined by Wageningen University and Research (WUR) in the standard NEN 2675+C1:2018.
Hemispherical light transmittance (Tₕₑₘ) and haze are measured following the standard NEN 2675+C1:2018. The hemispherical light transmittance is the weighted value of the measure of light transmittance at different angles from the point of light incidence defined for a particular range of wavelength, as for example:
   PAR Tₕₑₘ is the weighted value of light transmission for different light incident angles over a wavelength range comprised between 400 and 700 nm, based on NEN 2675+C1:2018.
   NIR transmission is the perpendicular transmission from 700 to 2000 nm, based on NEN 2675+C1:2018.
The normal emissivity is a ratio, in a direction normal to the surface, of the emissive power of the surface of the glass to the emissive power of a black body. The normal emissivity is measured in accordance with the norm EN 12898-2001F.
The refractive index n is calculated from the light spectrum wavelength at 550 nm.
The roughness is characterized through the Sa, Sz and Rsm values (expressed in micrometers). The roughness parameters were measured by confocal microscopy. The surface parameters (Sa and Sz) according to ISO 25178 standard, and the profile parameter (Rsm) by isolating a 2D profile which then gives access to the parameters defined in the ISO 4287 standard. Alternatively, one can use a 3D profilometer for the surface parameters (according to the ISO 25178 standard) and a 2D profilometer for the profile parameters (according to the ISO 4287 standard). The texture/roughness is a consequence of the existence of surface irregularities/patterns. These irregularities consist of bumps called “peaks” and cavities called “valleys”. On a section perpendicular to the etched surface, the peaks and valleys are distributed on either side of a “center line” (algebraic average) also called “mean line”. In a profile and for a measurement along a fixed length (called “evaluation length”).
   Sa (arithmetic mean height) expresses, as an absolute value, the difference in height of each point compared to the arithmetical mean of the surface, the Sa parameter is characterized by a standard deviation of 0.1 μm;
   Sz (maximum height) is defined as the sum of the largest peak height value and the largest pit depth value within the defined area, the Sz parameter is characterized by a standard deviation of 0.6 μm;
   Rsm (spacing value, sometimes also called Sm) is the average distance between two successive passages of the profile through the “mean line”; and this gives the average distance between the “peaks” and therefore the average value of the widths of the patterns, the Rsm parameter is characterized by a standard deviation of 1.0 μm.
The water contact angle is the angle made between the tangent to a water drop and the surface of the support. The measure is made following the standard method ASTM C 813-75 (1989)
Durability of the coating is assessed following the norm EN 1096.

The glass used for the invention is a clear glass or preferably an extra clear glass. The clear glass has a composition characterized by an iron content expressed in weight percent of Fe₂O₃ which is at most 0.1%. This value drops to at most 0.015% for the extra clear glass. The glass substrate of the invention has a thickness that is greater than 1 mm, preferably greater than 1.5 mm and more preferably greater than 2 mm. The thickness of the glass substrate is at most 20 mm, preferably at most 15 mm and more preferably at most 10 mm. Advantageously the thickness of the glass substrate is comprised between 3 and 6 mm. A 4 mm glass substrate with the extra clear composition has a light transmittance of about 91.7%.

### DESCRIPTION OF EMBODIMENTS/EXAMPLES

The following examples have been made in accordance with the invention.

### Example 1

A PVD stack has been deposited on one side of a 4 mm thick extra clear glass surface. The PVD stack has the following structure:

Glass/TZO (10 nm)/SiOₓ (40 nm XX)/TZO (117 nm)/SiOₓ (74 nm)/SiZrOₓ (23 nm)

Where TZO is a mixed oxide comprising titanium oxide and zirconium oxide with a weight composition of TiO₂/ZrO₂ of about 65/35. SiOₓ means a layer based on silicon oxide that may contain other elements and x is equal or smaller than 2. In the present example the SiOₓ layer is a mixture of 95 weight percent of silicon oxide and 5% of aluminium oxide. The two last oxide layers (SiOₓ and SiZrOₓ) are together the fourth low refractive index layer of the invention.

Example 2 is the same as example 1 except that prior to the deposition of the antireflective stack, the glass surface is submitted to a treatment as follow: the sheet of extra clear glass has been washed with deionized water and then dried. An acid etching solution, composed by volume of 50% NH₄HF₂, 25% water, 6% concentrated H₂SO₄, 6% of a 50% by weight aqueous HF solution, 10% K₂SO₄ and 3% (NH₄)₂SO₄, at 20-25° C., was allowed to contact the glass surface for 1.5 minutes. After removal of the acid solution, the glass surface is rinsed with water and washed. The textured glass sheet is then transferred to the coating line for deposition of the antireflective stack on the etched glass surface. A second antireflective stack is deposited on the other surface of the glass. The second antireflective stack is the same as the first.

The roughness of the glass surface of example 2 has been assessed after the etching procedure and before the antireflective stacks deposition. The parameters are given in the table 2 here below.

TABLE 2

| | Sa (μm) | Sz (μm) | Rsm (μm) |
|---|---|---|---|
| Example 2 | 0.5 | 5 | 80 |

Example 3 is the same as the example 2 but the acid etching solution was allowed to contact the glass surface for 3 minutes and as a consequence, the roughness is modified. The roughness parameters are given in the table 3 here below.

TABLE 3

| | Sa (μm) | Sz (μm) | Rsm (μm) |
|---|---|---|---|
| Example 3 | 1.4 | 8 | 70 |

For all examples, the performance has been evaluated in terms of hemispherical transmittance (Tₕₑₘ), PAR transmittance (T_{PAR}), NIR transmittance (T_{NIR}), NIR reflectance (R_{NIR}), emissivity and hortiscatter. The results of the examples of this invention are summarized below in the table 4 and values are given as percentage. The water contact angle has also been measured and is given at the end of the table 4.

TABLE 4

| | Example 1 | Example 2 | Example 3 |
|---|---|---|---|
| Tₕₑₘ (%) | 91.2 | 88.2 | 83.4 |
| T_{PAR} (%) | 98 | 97.6 | 97.3 |
| T_{NIR} (%) | 79.1 | 79.1 | 79.1 |
| R_{NIR} (%) | 20.9 | 20.9 | 20.9 |
| Emissivity (%) | 87 | 87 | 87 |
| Hortiscatter (%) | 0 | 10 | 60 |
| Water contact angle (°) | 28.8 | 28.5 | 25.6 |

It appears that all examples of the table 4 are capable to satisfy our requirements. Namely, both hemispherical and PAR transmittance remains high while 20% of the near infrared radiation is kept outside. The high emittance allows the heat to escape the greenhouse and the hortiscatter may be adapted according to the needs of grower.

1: A highly PAR transmitting glazing for a greenhouse comprising:
(a) a glass and
(b) an antireflective coating on at least one face of said glass, said antireflective coating comprising,
a first oxide layer having a high refractive index,
a second oxide layer having a low refractive index,
a third oxide layer having a high refractive index, and
a fourth oxide layer having a low refractive index;
wherein the highly PAR transmitting glazing has an NIR reflectance of at least 18%.

2: The highly PAR transmitting glazing of claim 1, wherein the antireflective coating is deposited on a glass surface facing an inside or an outside side of the greenhouse.

3: The highly PAR transmitting glazing of claim 1, wherein the glass face coated with the antireflective coating is textured and is facing a inside of the greenhouse.

4: The highly PAR transmitting glazing of claim 3, wherein each side of the glass is coated with the antireflective coating.

5: The highly PAR transmitting glazing according to claim 1, wherein the first and the third oxide layers have a high refractive index of at least 1.9.

6: The highly PAR transmitting glazing according to claim 1, wherein the second and the fourth oxide layers have a low refractive index of at most 1.7.

7: The highly PAR transmitting glazing according to claim 1, wherein the first oxide layer has a thickness between 5 and 15 nm, the second oxide layer has a thickness between 30 and 50 nm, the third oxide layer has thickness between 100 and 130 nm, and the fourth oxide layer has a thickness between 80 and 110 nm.

8: The highly PAR transmitting glazing according to claim 1, wherein the fourth oxide layer is a two part layer comprising a first part and a second part, both the first part and the second part being oxide layers having a low refractive index.

9: The highly PAR transmitting glazing according to claim 1, wherein the antireflective coating is hydrophilic and has a contact angle below 32°.

10: The highly PAR transmitting glazing according to claim 1, wherein a PAR transmittance is at least 92%.

11: The highly PAR transmitting glazing according to claim 1, wherein a hemispherical transmittance is at least 83%.

12: The highly PAR transmitting glazing according to claim 1, wherein an emissivity is at least 80%.

13: The highly PAR transmitting glazing according to claim 1, wherein the highly PAR transmitting glazing has an NIR reflectance of at least 19%.

14: The highly PAR transmitting glazing according to claim 1, wherein the first and the third oxide layers have a high refractive index of at least 2.1.

15: The highly PAR transmitting glazing to claim 1, wherein the second and the fourth oxide layers have a low refractive index of at most 1.5.

16: The highly PAR transmitting glazing according to claim 1, wherein the antireflective coating is hydrophilic and has a contact angle below 30°.

17: The highly PAR transmitting glazing to claim 1, wherein a PAR transmittance is at least 94%.

18: The highly PAR transmitting glazing to claim 1, wherein a hemispherical transmittance is at least 89%.

19: The highly PAR transmitting glazing according to claim 1, wherein an emissivity is at least 83%.

20: The highly PAR transmitting glazing according to claim 1, wherein the highly PAR transmitting glazing has an NIR reflectance of at least 20%.
